(19) United States
(12) Patent Application Publication
(10) Pub. No.: US 2026/0321873 A1
(43) Pub. Date: Oct. 15, 2026

(54) BATTERY PACK AND VEHICLE INCLUDING THE SAME

(71) Applicants: HYUNDAI MOTOR COMPANY, Seoul (KR); Kia Corporation, Seoul (KR); SAMSUNG SDI CO., LTD., Yongin-si (KR)

(72) Inventors: Chan Sol KIM, Hwaseong-si (KR); Gun Woo KO, Hwaseong-si (KR); Kyung Mo KIM, Hwaseong-si (KR); Si Won KIM, Hwaseong-si (KR); Jong Gyu PARK, Hwaseong-si (KR); Jae Soon PARK, Yongin-si (KR); Kil Seok LEE, Yongin-si (KR)

(21) Appl. No.: 19/362,924

(22) Filed: Oct. 20, 2025

(30) Foreign Application Priority Data
Apr. 15, 2025 (KR) 10-2025-0049047

(51) Int. Cl. H01M 50/358; B60L 50/64; H01M 10/613; H01M 10/625; H01M 10/647; H01M 10/653; H01M 10/6556; H01M 50/209; H01M 50/249; H01M 50/271; H01M 50/342

(52) U.S. Cl. CPC H01M 50/358; H01M 10/613; H01M 10/625; H01M 10/647; H01M 10/653; H01M 10/6556; H01M 50/209; H01M 50/249; H01M 50/271; H01M 50/3425; B60L 50/64; H01M 2220/20

(57) ABSTRACT

A battery pack including a plurality of batteries includes a plurality of batteries comprising electrodes and separators, the plurality of batteries arranged along a forward/rearward direction; and a lower cover part disposed below the plurality of batteries, wherein each of the plurality of batteries comprises an upper surface and a lower surface disposed opposite each other in an upward/downward direction, wherein the lower surface of each of the plurality of batteries comprises a vent hole, wherein the lower cover part comprises a first region facing the vent hole in the upward/downward direction, and wherein the first region of the lower cover part comprises a passageway space in gas communication with the vent hole.

### CROSS-REFERENCE TO RELATED APPLICATION

This application claims priority to and the benefit of Korean Patent Application No. 10-2025-0049047 filed in the Korean Intellectual Property Office on Apr. 15, 2025, the entire contents of which are incorporated herein by reference.

### TECHNICAL FIELD

The present disclosure relates to a battery pack and a vehicle including the same, and more particularly, to a battery pack capable of being mounted in a vehicle, and a vehicle including the same.

### BACKGROUND

In the related art, a battery pack mounted in a vehicle or the like may be configured such that a lower cover and a cooling plate are disposed at a lower side of the battery pack to protect a battery, and an upper cover is coupled to an upper side of the battery pack. In particular, the upper cover generally may adopt a vent structure for discharging high-temperature gas upward in the event of thermal runaway occurring in the battery pack.

That is, in the case of the battery pack in the related art, a space for protecting the battery may need to be ensured at the lower side of the battery pack, and a space for gas venting may need to be ensured at the upper side of the battery pack. However, this configuration may lead to a deterioration in energy density of the battery pack. In particular, the battery pack mounted in the vehicle essentially may require both the space for protecting the battery from external impact and the space for gas venting. For this reason, in the related art, there is a significant problem with a deterioration in energy density of the battery pack for a vehicle.

### SUMMARY

Aspects of the present disclosure can improve an energy density of a battery pack, for example, by integrating a space for protecting a battery in the battery pack and a space for gas venting.

Aspects of the present disclosure provide a battery pack including: a plurality of batteries comprising electrodes and separators, the plurality of batteries arranged along a forward/rearward direction; and a lower cover part disposed below the plurality of batteries, wherein each of the plurality of batteries comprises an upper surface and a lower surface disposed opposite each other in an upward/downward direction, wherein the lower surface of each of the plurality of batteries comprises a vent hole, wherein the lower cover part comprises a first region facing the vent hole in the upward/downward direction, and wherein the first region of the lower cover part comprises a passageway space in gas communication with the vent hole.

The lower cover part can include a first lower cover part disposed below the plurality of batteries; and a second lower cover part disposed below the first lower cover part, and wherein the passageway space is defined by the first lower cover part and the second lower cover part.

The first lower cover part and the second lower cover part can be fixed in a state of being tightly attached to each other.

The first lower cover part and the second lower cover part can be fixed in the state of being tightly attached to each other in a second region of the lower cover part, wherein the second region of the lower cover part can be disposed outside a periphery of the passageway space.

The first lower cover part can include: a first-first lower cover region being spaced apart from the plurality of batteries; and a first-second lower cover region protruding and extending upward from the first-first lower cover region, and wherein the passageway space can be defined by the first-second lower cover region and the second lower cover part.

The battery pack can include a buffer pad member disposed between the first-first lower cover region and the plurality of batteries.

The first lower cover part can include a first-third lower cover region extending in a direction toward the passageway space from the first-second lower cover region and configured to support the plurality of batteries, and wherein the first-third lower cover region can include a communication hole in gas communication with the vent hole, and wherein the communication hole faces the vent hole.

The battery pack can include a heat-resistant member disposed in a third region of an upper surface of the second lower cover part, the third region of the upper surface of the second lower cover part faces the passageway space in the upward/downward direction.

The first-second lower cover region can include a first first-second lower cover region and a second first-second lower cover region spaced apart from each other in a leftward/rightward direction, wherein the leftward/rightward direction can intersect the forward/rearward direction, wherein the passageway space can be interposed between the first first-second lower cover region and the second first-second lower cover region.

The passageway space can extend longitudinally in the forward/rearward direction.

The battery pack can include: a venting device disposed at a first side of a pack casing and configured to be opened at a predetermined pressure or higher, wherein an end of the passageway space, extending in the forward/rearward direction, can be connected to the venting device.

The venting device can be disposed only at the first side of the pack casing based on the forward/rearward direction.

The communication hole can include a plurality of communication holes spaced apart from one another in the forward/rearward direction.

The plurality of communication holes can correspond to the vent holes in the plurality of batteries in a one-to-one manner.

The battery pack can include: a pack casing having a space that accommodates the plurality of batteries, wherein the space of the pack casing can face the lower cover.

The battery pack can include a cooling plate disposed above the pack casing and having a cooling flow path for a cooling fluid to flow through.

The lower surface of the cooling plate can be configured to press the plurality of batteries.

Each of the plurality of batteries can include electrode leads, and wherein the electrode leads can be disposed on a lower surface of each of the batteries.

The electrode leads can include a first electrode lead and a second electrode lead spaced apart from each other in a leftward/rightward direction intersecting the forward/rearward direction, and wherein the vent hole can be disposed between the first electrode lead and the second electrode lead.

Aspects of the present disclosure provides a vehicle having a side to which the battery pack is fixedly coupled, the lower cover part being provided below the plurality of batteries.

According to the present disclosure, the space for protecting the battery in the battery pack and the space for gas venting can be integrated, thereby improving the energy density of the battery pack.

### BRIEF DESCRIPTION OF THE DRAWINGS

FIG. 1 is an exploded perspective view of a battery pack according to an example of the present disclosure.

FIG. 2 is a view illustrating a state in which the battery pack according to an example of the present disclosure is inverted in an upward/downward direction.

FIG. 3 is a view schematically illustrating a cross-sectional structure of the battery pack according to an example of the present disclosure.

FIG. 4 is a view for explaining a pack casing and a buffer pad member provided in the battery pack according to an example of the present disclosure, i.e., a view illustrating a state in which the battery pack is inverted in the upward/downward direction.

FIG. 5 is an exploded perspective view of a lower cover part provided in the battery pack according to an example of the present disclosure.

FIG. 6 is an enlarged view illustrating a venting device of the battery pack according to an example of the present disclosure and the surroundings of the venting device.

### DETAILED DESCRIPTION

Hereinafter, a battery pack and a vehicle including the same according to the present disclosure will be described.

### Battery Pack

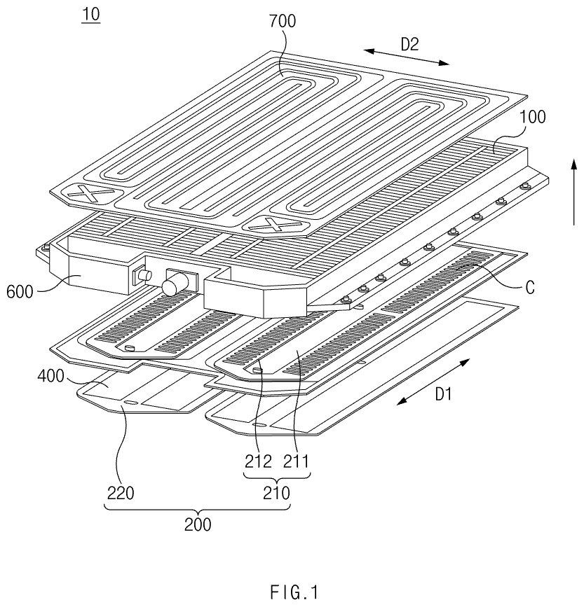

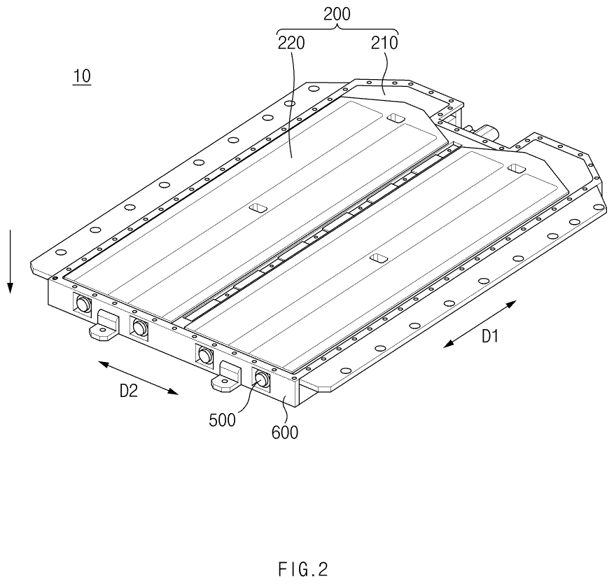

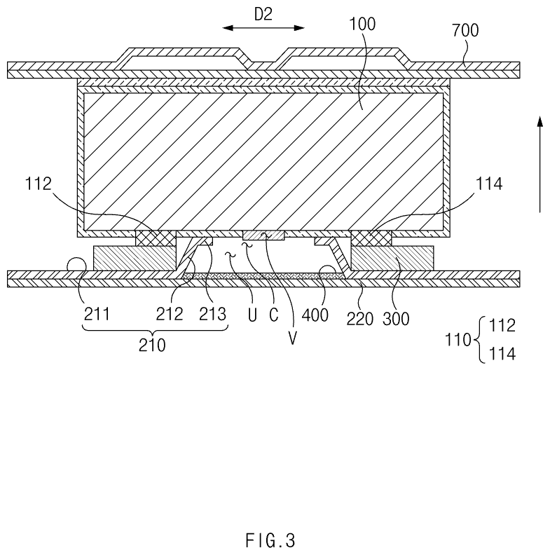

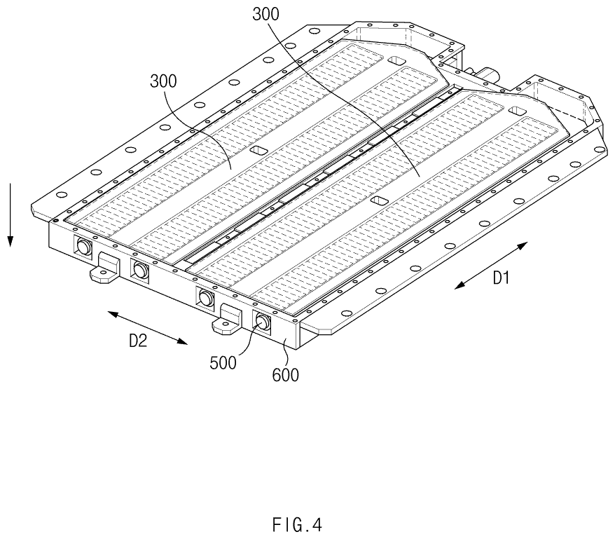

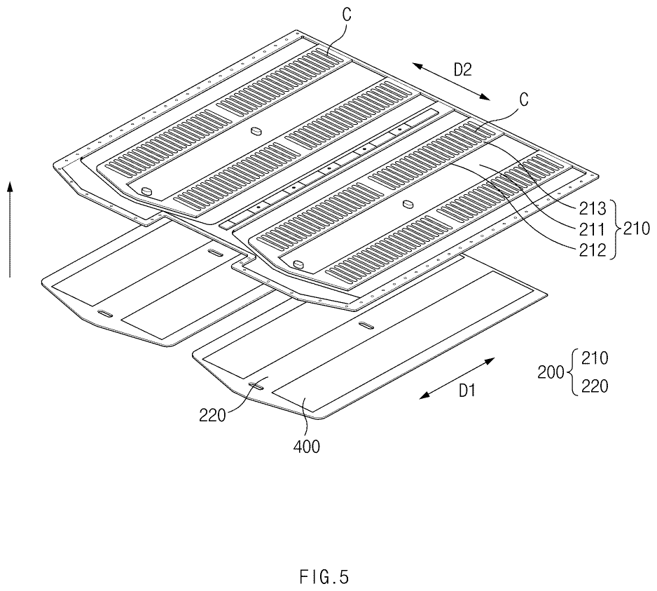

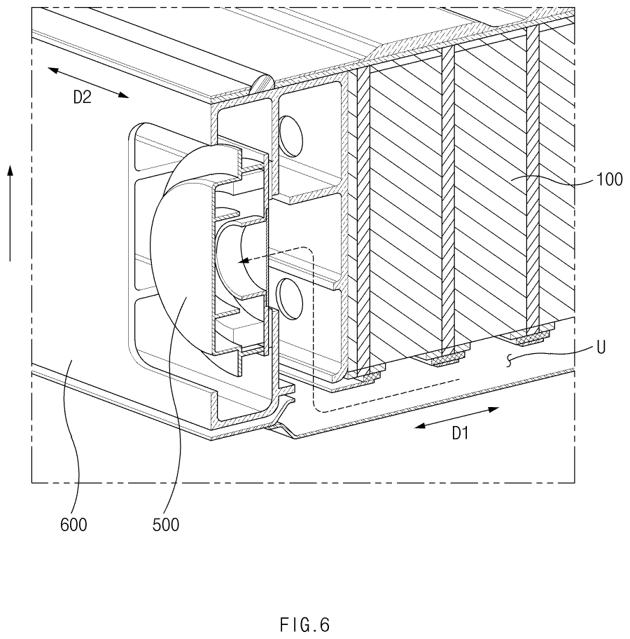

FIG. 1 is an exploded perspective view of a battery pack according to the present disclosure, and FIG. 2 is a view illustrating a state in which the battery pack according to the present disclosure is inverted in an upward/downward direction. FIG. 3 is a view schematically illustrating a cross-sectional structure of the battery pack according to the present disclosure, and FIG. 4 is a view for explaining a pack casing and a buffer pad member provided in the battery pack according to the present disclosure, i.e., a view illustrating a state in which the battery pack is inverted in the upward/downward direction. FIG. 5 is an exploded perspective view of a lower cover part provided in the battery pack according to the present disclosure, and FIG. 6 is an enlarged view illustrating a venting device of the battery pack according to the present disclosure and the surroundings of the venting device.

In some implementations, in the drawings in the present application, arrows illustrated without separate reference numerals D1 and D2 indicate an upward direction. That is, the drawing in which the arrow indicates the upward direction (FIGS. 1, 3, 5, and 6) is a drawing based on an actual usage state of the battery pack according to the present disclosure (e.g., a state in which the battery pack is mounted in the vehicle). In contrast, the drawing in which the arrow indicates a downward direction (FIGS. 2 and 4) is a drawing based on a state in which the battery pack according to the present disclosure is inverted in the upward/downward direction in comparison with the actual usage state of the battery pack according to the present disclosure.

With reference to FIGS. 1 to 3, a battery pack 10 according to the present disclosure can include a plurality of batteries 100 including electrodes and separators and provided in a forward/rearward direction D1, and a lower cover part 200 provided below the plurality of batteries 100.

The battery 100 provided in the battery pack 10 according to the present disclosure can be a prismatic battery. However, the battery 100 provided in the battery pack 10 according to the present disclosure can be other types of batteries, such as pouch-type batteries or cylindrical batteries.

In some implementations, as illustrated in FIG. 3, according to the present disclosure, one or more vent holes V can be formed in lower surfaces of the plurality of batteries 100. In case that the battery 100 is a prismatic battery, as described above, the vent hole V can be formed in an exterior material of the prismatic battery. For example, the vent hole V can be closed at ordinary times. In case that the internal pressure of the battery 100 exceeds a predetermined value, the vent hole V can be opened to form a flow path through which gas in the battery 100 can be discharged to the outside. The method of discharging gas inside the battery by using the vent hole V can be substituted with the content related to the prismatic battery widely known in the related art.

With continued reference to FIG. 3, a passageway space U, which communicates with the vent hole V, can be formed in a region of the lower cover part 200 that faces the vent hole V in an upward/downward direction H. The passageway space U can provide a path so that materials, such as gas discharged through the vent hole V, can be discharged to the outside of the battery pack 10.

In some implementations, according to the present disclosure, the lower cover part 200 can have a shape made by assembling a plurality of members. For example, as illustrated in FIGS. 1 to 4, the lower cover part 200 can include a first lower cover part 210 provided below the plurality of batteries 100, and a second lower cover part 220 provided below the first lower cover part 210. In some implementations, the passageway space U can be defined by the first lower cover part 210 and the second lower cover part 220. In some implementations, the configuration in which the passageway space U is defined by the first lower cover part 210 and the second lower cover part 220 can be understood as a configuration in which a boundary of the passageway space is defined by an inner surface of the first lower cover part 210 and an inner surface of the second lower cover part 220. In some implementations, for example, unlike the first lower cover part 210, an entire region of the second lower cover part 220 can have a substantially flat plate-like shape. For example, as illustrated in FIG. 3 and the like, a part of the first lower cover part 210 and a part of the second lower cover part 220 can be fixed in a state of being tightly attached to each other in the upward/downward direction. The passageway space U can be formed in a region in which the first lower cover part 210 and the second lower cover part 220 are spaced apart from each other in the upward/downward direction without being tightly attached to each other. For example, in the region in which the first lower cover part 210 and the second lower cover part 220 are tightly attached to each other, the first lower cover part 210 and the second lower cover part 220 can be coupled by being press-fitted with each other in a region that at least surrounds the passageway space U.

In some implementations, the first lower cover part 210 can be divided into a plurality of regions depending on the shape thereof. For example, the first lower cover part 210 can include a first-first lower cover region 211 provided to be spaced apart downward from the plurality of batteries 100, and a first-second lower cover region 212 protruding and extending upward from the first-first lower cover region 211. For example, FIG. 3 illustrates a state in which the first-second lower cover region 212 extends upward from the first-first lower cover region 211 and/or extends inclinedly. In some implementations, an angle is formed between the first-first lower cover region 211 and first-second lower cover region 212. The angle formed between the first-first lower cover region 211 and first-second lower cover region 212 can be in a range of about 30° to about 90°. In some implementations, the passageway space U can be defined by the first-second lower cover region 212 and the second lower cover part 220. For example, a boundary of the passageway space U can be defined by an inner surface of the first-second lower cover region 212 and an inner surface of the second lower cover part 220.

In addition, as illustrated in FIGS. 3 and 4, the battery pack 10 according to the present disclosure can further include a buffer pad member 300 provided between the first-first lower cover region 211 and the battery 100. The battery pack 10 according to the present disclosure can be mounted in an exterior device (e.g., a vehicle) in a state in which the lower cover part 200 is positioned at the lower side of the battery pack 10. The buffer pad member 300 can be configured to absorb impact applied to a lower region of the battery pack 10. The buffer pad member 300 can include or be made of a material that can be elastically transformed in case that an external force is applied. Examples of the buffer pad member 300 include rubber, silicone, and elastomeric plastics.

In some implementations, as illustrated in FIG. 3 and the like, the first lower cover part 210 can further include a first-third lower cover region 213. In some implementations, the first-third lower cover region 213 can extend in a direction toward the passageway space U from the first-second lower cover region 212. In some implementations, the first-third lower cover region 213 can extend in the leftward/rightward direction D2 from the first-second lower cover region 212. In some implementations, the first-first lower cover region 211 can define a first virtual plane including the entire portion of the first-first lower cover region 211, and the first-third lower cover region 213 can define a second virtual plane including the entire portion of the first-third lower cover region 213. In some implementations, the first virtual plane can be parallel to the second virtual plane.

In some implementations, an angle is formed between the first-second lower cover region 212 and the first-third lower cover region 213. The angle formed between the first-second lower cover region 212 and first-third lower cover region 213 can be in a range of about 90° to about 150°. In some implementations, and the first-third lower cover region 213 can be configured to support the plurality of batteries 100. The first-third lower cover region 213 can define an upper boundary of the passageway space U.

In some implementations, according to the present disclosure, the first-third lower cover region 213 can have a communication hole C that communicates with the vent hole V and faces the vent hole V in the upward/downward direction H. For example, the communication hole C can be in gas/fluid communication with the vent hole V. The communication hole C can be configured to connect the vent hole V with the passageway space U.

In some implementations, with reference to FIGS. 1 and 3 and the like, the battery pack 10 according to the present disclosure can further include a heat-resistant member 400 provided in a region of an upper surface of the second lower cover part 220 that faces the passageway space U in the upward/downward direction H. The heat-resistant member 400 can be configured to prevent or minimize a situation in which thermal energy of high-temperature gas, which is supplied to the passageway space U through the vent hole V of the battery 100, is transferred to the peripheral batteries or the second lower cover part 220. Therefore, the heat-resistant member 400 can include or be made of a material having high heat resistance and low thermal conductivity.

In some implementations, the first-second lower cover region 212 can be provided as two first-second lower cover regions 212 spaced apart from each other in a leftward/rightward direction D2, which intersects the forward/rearward direction D1, with the passageway space U interposed therebetween. In this case, the above-mentioned passageway space U can be formed between the above-mentioned two first-second lower cover regions 212. In addition, the passageway space U can extend longitudinally in the forward/rearward direction D1. Therefore, the gas introduced into the passageway space U through the vent hole V can move in the forward/rearward direction D1.

The battery pack 10 can further include a venting device 500 provided at one side of the pack casing based on the forward/rearward direction D1 and configured to be opened at a predetermined pressure or higher. The venting device 500 can be configured to provide a path through which the gas flowing in the passageway space U can be discharged to the outside. However, the venting device 500 is closed at ordinary times (e.g., under normal operating conditions) by default. For example, the In case that the applied pressure exceeds a predetermined value, the venting device 500 can operate such that at least a part thereof is ruptured or opened.

In some implementations, as illustrated in FIG. 6, according to the present disclosure, an end of the passageway space U based on the forward/rearward direction D1 can be connected to the venting device 500. In some implementations, with reference to FIGS. 4 and 6 and the like, the above-mentioned venting device 500 can be provided only at one side of the pack casing based on the forward/rearward direction D1. This can be intended to ensure that when the venting device 500 is opened, the inside gas is discharged only through one side end of the passageway space U, and the other side end of the passageway space U still remains blocked by an inner surface of the pack casing.

In some implementations, as illustrated in FIGS. 1 and 5 and the like, the communication hole C can include a plurality of communication holes C spaced apart from one another in the forward/rearward direction D1 of the battery pack 10. More particularly, the plurality of communication holes C can be provided to correspond, in a one-to-one manner, to the vent holes V in the plurality of batteries 100 in the battery pack 10. The plurality of communication holes C can be provided to face, in the upward/downward direction H, the vent holes V corresponding to the respective communication holes C. In this way, a heat transfer to another adjacent battery 100 in the event of thermal runaway occurring in some of the plurality of batteries 100 provided in the battery pack 10 can be prevented. For example, as shown in FIG. 5, in some implementations, a width of the communication hole C in the leftward/rightward direction D2 is greater than a width of the communication hole C in the forward/rearward direction D1.

Referring to FIGS. 1, 2, and 4 and the like, the battery pack 10 according to the present disclosure can further include a pack casing 600 configured to define a space that accommodates the plurality of batteries 100. For example, the pack casing 600 can have a shape that opens upward and downward. Therefore, in case that the above-mentioned lower cover part 200 is assembled to a lower portion of the pack casing 600, the lower cover part 200 can directly face the batteries 100 accommodated in the pack casing 600. In addition, the plurality of batteries 100 can be fixedly coupled to lateral surfaces of the pack casing 600 based on the horizontal directions D1 and D2.

In some implementations, with reference to FIGS. 1 and 3, the battery pack 10 according to the present disclosure can further include a cooling plate 700 provided above the pack casing 600 and having therein a cooling flow path through which a cooling fluid flows. The cooling plate 700 can be configured to cool the batteries 100 by means of heat exchange between the batteries 100 and the cooling fluid flowing in the cooling plate 700. More particularly, as illustrated in FIG. 3 and the like, at least a part of a lower surface of the cooling plate 700 can be configured to press the plurality of batteries 100. In this case, the configuration in which the cooling plate 700 presses the plurality of batteries 100 can be interpreted as including not only a case in which the cooling plate 700 is directly and tightly attached to the plurality of batteries 100 but also a case in which a separate member is provided between the cooling plate 700 and the plurality of batteries 100 and the cooling plate 700 indirectly presses the plurality of batteries 100 through the separate member.

In some implementations, as illustrated in FIG. 3, the plurality of batteries 100 provided in the battery pack 10 can each include electrode leads 110. In this case, the electrode leads 110 can be provided on a lower surface of the battery 100. For example, FIG. 3 illustrates that the electrode leads 110 face the buffer pad member 300 in the upward/downward direction.

In some implementations, the electrode leads 110 provided in each of the batteries 100 can include first and second electrode leads 112 and 114 spaced apart from each other in the leftward/rightward direction D2 intersecting the forward/rearward direction D1. In this case, the vent hole V provided in each of the batteries 100 can be provided between the first electrode lead 112 and the second electrode lead 114.

According to the present disclosure, high-temperature gas produced in the event of thermal runaway occurring in the battery 100 in the battery pack 10 can be discharged to the outside of the battery pack 10 through the lower region of the battery pack 10. For example, according to the present disclosure, the high-temperature gas can be discharged to the outside of the battery pack 10 through the lower cover part 200 positioned below the batteries 100. Therefore, the lower region of the battery pack 10 can serve as not only i) a physical space for protecting the batteries 100 from impact applied to the lower portion of the battery pack 10, but also ii) a path through which high-temperature gas produced in the battery pack 10 is discharged to the outside of the battery pack 10. In some implementations, the above-mentioned advantages can be enhanced when the battery pack 10 is disposed in a floor region of a vehicle 10, as described below.

### VEHICLE

A vehicle according to the present disclosure can include the battery pack 10. For example, the vehicle can be an electric vehicle or a hybrid electric vehicle. The description of the battery pack provided in the vehicle according to the present disclosure can be replaced with the above-mentioned description for the battery pack according to the present disclosure.

The present disclosure has been described with reference to the limited implementations and the drawings, but the present disclosure is not limited thereby. The present disclosure can be carried out in various forms by those skilled in the art, to which the present disclosure pertains, within the technical spirit of the present disclosure and the scope equivalent to the appended claims.

What is claimed is:

1. A battery pack comprising:
a plurality of batteries comprising electrodes and separators, the plurality of batteries arranged along a forward/rearward direction; and
a lower cover part disposed below the plurality of batteries,
wherein each of the plurality of batteries comprises an upper surface and a lower surface disposed opposite each other in an upward/downward direction, wherein the lower surface of each of the plurality of batteries comprises a vent hole,
wherein the lower cover part comprises a first region facing the vent hole in the upward/downward direction, and
wherein the first region of the lower cover part comprises a passageway space in gas communication with the vent hole.

2. The battery pack of claim 1, wherein the lower cover part comprises:
a first lower cover part disposed below the plurality of batteries; and
a second lower cover part disposed below the first lower cover part, and
wherein the passageway space is defined by the first lower cover part and the second lower cover part.

3. The battery pack of claim 2, wherein the first lower cover part and the second lower cover part are fixed in a state of being tightly attached to each other.

4. The battery pack of claim 3, wherein the first lower cover part and the second lower cover part are fixed in the state of being tightly attached to each other in a second region of the lower cover part, wherein the second region of the lower cover part is disposed outside a periphery of the passageway space.

5. The battery pack of claim 2, wherein the first lower cover part comprises:
a first-first lower cover region being spaced apart from the plurality of batteries; and
a first-second lower cover region protruding and extending upward from the first-first lower cover region, and
wherein the passageway space is defined by the first-second lower cover region and the second lower cover part.

6. The battery pack of claim 5, comprising:
a buffer pad member disposed between the first-first lower cover region and the plurality of batteries.

7. The battery pack of claim 5, wherein the first lower cover part comprises a first-third lower cover region extending in a direction toward the passageway space from the first-second lower cover region and configured to support the plurality of batteries, and
wherein the first-third lower cover region comprises a communication hole in gas communication with the vent hole, and wherein the communication hole faces the vent hole.

8. The battery pack of claim 2, comprising:
a heat-resistant member disposed in a third region of an upper surface of the second lower cover part, the third region of the upper surface of the second lower cover part faces the passageway space in the upward/downward direction.

9. The battery pack of claim 7, wherein the first-second lower cover region comprises a first first-second lower cover region and a second first-second lower cover region spaced apart from each other in a leftward/rightward direction, wherein the leftward/rightward direction intersects the forward/rearward direction, wherein the passageway space is interposed between the first first-second lower cover region and the second first-second lower cover region.

10. The battery pack of claim 9, wherein the passageway space extends longitudinally in the forward/rearward direction.

11. The battery pack of claim 10, comprising:
a venting device disposed at a first side of a pack casing and configured to be opened at a predetermined pressure or higher,
wherein an end of the passageway space, extending in the forward/rearward direction, is connected to the venting device.

12. The battery pack of claim 11, wherein the venting device is disposed only at the first side of the pack casing based on the forward/rearward direction.

13. The battery pack of claim 9, wherein the communication hole comprises a plurality of communication holes spaced apart from one another in the forward/rearward direction.

14. The battery pack of claim 13, wherein the plurality of communication holes correspond to the vent holes in the plurality of batteries in a one-to-one manner.

15. The battery pack of claim 1, further comprising:
a pack casing having a space that accommodates the plurality of batteries, wherein the space of the pack casing faces the lower cover.

16. The battery pack of claim 15, further comprising:
a cooling plate disposed above the pack casing and having a cooling flow path for a cooling fluid to flow through.

17. The battery pack of claim 16, wherein a lower surface of the cooling plate is configured to press the plurality of batteries.

18. The battery pack of claim 1, wherein each of the plurality of batteries includes electrode leads, and
wherein the electrode leads are disposed on a lower surface of each of the batteries.

19. The battery pack of claim 18, wherein the electrode leads comprise a first electrode lead and a second electrode lead spaced apart from each other in a leftward/rightward direction intersecting the forward/rearward direction, and
wherein the vent hole is disposed between the first electrode lead and the second electrode lead.

20. A vehicle having a side to which a battery pack is fixedly coupled, wherein the battery pack comprises:
a plurality of batteries comprising electrodes and separators, the plurality of batteries arranged along a forward/rearward direction; and
a lower cover part disposed below the plurality of batteries,
wherein each of the plurality of batteries comprises an upper surface and a lower surface disposed opposite each other in an upward/downward direction, wherein the lower surface of each of the plurality of batteries comprises a vent hole,
wherein the lower cover part comprises a first region facing the vent hole in the upward/downward direction, and
wherein the first region of the lower cover part comprises a passageway space in gas communication with the vent hole.
